(19) United States
(12) Patent Application Publication
(10) Pub. No.: US 2026/0031658 A1
(43) Pub. Date: Jan. 29, 2026

(54) POWER CIRCUIT

(71) Applicant: Sanken Electric Co., Ltd., Saitama-ken (JP)

(72) Inventor: MASAKI KATO, Saitama-ken (JP)

(73) Assignee: Sanken Electric Co., Ltd., Saitama-ken (JP)

(21) Appl. No.: 19/235,564

(22) Filed: Jun. 11, 2025

(30) Foreign Application Priority Data
Jul. 23, 2024 (JP) 2024-117733
Apr. 18, 2025 (JP) 2025-068571

(51) Int. Cl. H02J 50/20; H01M 10/44; H02M 1/36

(52) U.S. Cl. CPC H02J 50/20; H01M 10/44; H02M 1/36

(57) ABSTRACT

An RF signal (RF0) is input to a rectifier circuit and rectified to obtain a DC signal (DC1) converted by an output part into a DC signal DC2 suitable for charging a battery, and output to the battery 100. In the power circuit, the intensity of RF0 and the voltage and current of DC1 are recognized, and DC2 output from the output part is controlled accordingly. A DC input monitor circuit monitors the values of the voltage and current of DC1. The output part and the battery can be considered as a virtual load resistance from the perspective of the side of the preceding rectifier circuit. A power conversion efficiency from RF0 to DC2 depends on RL. An output adjustment part compares the recognized RL with the value of RL at which the conversion efficiency η peaks and controls increase/decrease of the current of DC2 accordingly.

### CROSS-REFERENCE TO RELATED APPLICATION

This application claims the priority benefit of Japan application serial no. 2024-117733, filed on Jul. 23, 2024 and Japan application serial no. 2025-068571, filed on Apr. 18, 2025. The entirety of each of the above-mentioned patent applications is hereby incorporated by reference herein and made a part of this specification.

### BACKGROUND

### Technical Field

The invention relates to a power circuit that supplies to a load a DC signal generated based on a received high frequency signal.

### Description of Related Art

A power circuit (rectenna device) that outputs DC power based on power (RF power) input wirelessly such as by microwaves is used for various applications, such as battery charging. In this case, the input RF signal is rectified to obtain a DC signal, and the DC signal is output at a desired voltage or current by a DC-DC converter. At this time, since the intensity of the input RF signal is not constant and varies greatly depending on the situation, the conversion efficiency from the input RF power to the output DC power in such a power circuit generally changes significantly according to the situation.

In such case, it is preferable to maintain the conversion efficiency as high as possible. Therefore, for example, Patent Document 1 describes a technology in which the output of the rectifier circuit into which the input RF signal is input is temporarily opened, the output voltage after rectification at this time is monitored, and, correspondingly, the voltage of the DC output that is output is determined so that the conversion efficiency is maximized. Patent Document 1 describes that the voltage at which the conversion efficiency is maximized is approximately ½ of the voltage (open voltage) in such case. That is, even in the case where the RF power fluctuates, by measuring the open voltage in this way and then controlling and outputting the DC voltage in this way, a consistently high conversion efficiency can be obtained. Patent Document 2 discloses a configuration for controlling DC output for such purpose.

### PRIOR ART DOCUMENT(S)

### Patent Document(s)

[Patent Document 1] Japanese Patent No. 6152919
[Patent Document 2] Japanese Patent Application Laid-open No. 2011-62022

In the technology described in Patent Document 1, in the case where the output of the rectifier circuit is temporarily opened, when the input RF power is large, the rectifier element may be damaged. Furthermore, at the time of opening the output of the rectifier circuit for such control, the DC output is temporarily stopped. Therefore, the output efficiency may deteriorate substantially. Therefore, in the power circuit that outputs the DC power from the received RF power, a technology capable of obtaining high conversion efficiency without damaging the rectifier element is required.

### SUMMARY

An aspect of the invention provides a power circuit that outputs a direct current (DC) signal generated based on a high frequency signal that is received to a load. The power circuit includes: a rectifier circuit, rectifying the high frequency signal and outputting a first DC signal; an output part, outputting, as the DC signal, a second DC signal obtained by converting the first DC signal using a DC-DC converter; and an output adjustment part, recognizing a control parameter recognized in accordance with an output state of the first DC signal, and controlling an increase or decrease of a current of the second DC signal output from the output part in accordance with the control parameter, so that a power conversion efficiency from the high frequency signal to the DC signal is facilitated.

### BRIEF DESCRIPTION OF THE DRAWINGS

FIG. 1 is a diagram showing a configuration of a power circuit according to the first embodiment.

FIG. 2 is a diagram showing the relationship between power conversion efficiency and load resistance in the power circuit according to the first embodiment.

FIG. 3 is a diagram showing the configuration of an output adjustment part in the power circuit according to the first embodiment.

FIG. 4 is a flowchart showing an operation of the output adjustment part in the power circuit according to the first embodiment.

FIG. 5 is a diagram showing an example of the configuration of an output part in the power circuit according to the first embodiment.

FIG. 6 is a diagram showing the relationship between power conversion efficiency and first output voltage in a power circuit according to the second embodiment.

FIG. 7 is a diagram showing the configuration of an output adjustment part in the power circuit according to the second embodiment.

FIG. 8 is a flowchart showing an operation of the output adjustment part in the power circuit according to the second embodiment.

FIG. 9 is a diagram showing the relationship between power conversion efficiency and first output current in a power circuit according to the third embodiment.

FIG. 10 is a diagram showing the configuration of an output adjustment part in the power circuit according to the third embodiment.

FIG. 11 is a flowchart showing an operation of the output adjustment part in the power circuit according to the third embodiment.

FIG. 12 is a diagram showing a configuration of a power circuit according to the fourth embodiment.

FIG. 13 is a diagram showing the configuration of an output adjustment part in the power circuit according to the fourth embodiment.

FIG. 14 shows two examples of the first output voltage in the power circuit according to the fourth and fifth embodiments through time.

FIG. 15 is a flowchart showing an operation of the output adjustment part in the power circuit according to the fourth embodiment.

FIG. 16 is a diagram showing a configuration of a power circuit according to the fifth embodiment.

FIG. 17 is a diagram showing the configuration of an output adjustment part in the power circuit according to the fifth embodiment.

FIG. 18 is a flowchart showing an operation of the output adjustment part in the power circuit according to the fifth embodiment.

### DESCRIPTION OF THE EMBODIMENTS

According to the power circuit of the invention, a high power conversion efficiency can be obtained without damaging the rectifier element.

In the following, exemplary embodiments of the invention will be described based on the attached drawings. In the power circuit of the invention, the first DC signal, which is the output of the rectifier circuit, is converted into the second DC signal using a DC-DC converter by the output part, and then output. Here, in particular, a recognized control parameter is set according to the output state of the first DC signal, and the output part is controlled according to the control parameter, so that the power conversion efficiency from the input high frequency signal to the output DC signal is facilitated. Multiple control parameters can be set as such control parameter.

### First Embodiment

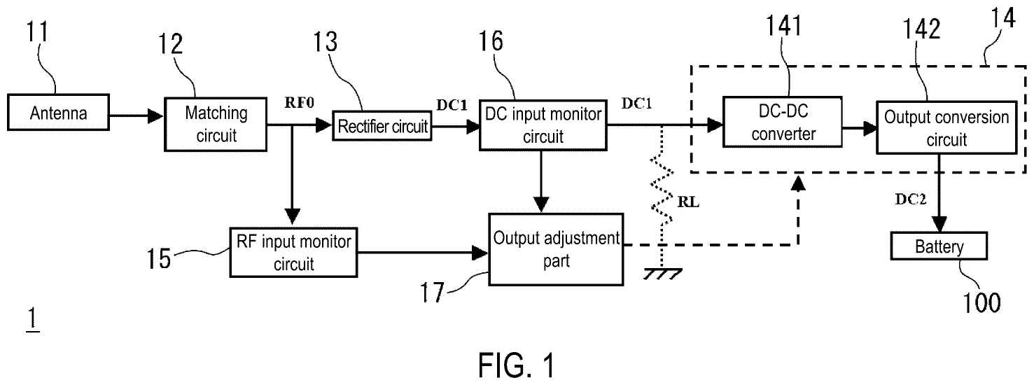

FIG. 1 is a diagram showing the overall configuration of a power circuit 1 according to the first (disclosed) embodiment. Here, the output (load) of the power circuit 1 is set as a battery 100, and the power circuit 1 serves as a charging circuit of the battery 100. Here, the RF input, which is a microwave, is received by an antenna 11. The intensity of the RF input (RF signal) is not constant and varies according to the situation.

The RF signal (RF0: high frequency signal) after the received RF input (RF signal) passes through a matching circuit 12 for matching the impedance of the antenna 11 is input to and rectified by the rectifier circuit 13, and a DC signal (DC1: first DC signal) is obtained. DC1 is converted by the output part 14 into a DC signal DC2 with a current (voltage) and a form suitable for charging the battery 100, and output to the side of the battery 100. The output part 14 includes a DC-DC converter 141 and an output conversion circuit 142 that sets the DC signal of such output into a converted DC output (DC2: second DC signal) in a form suitable for charging the battery 100. In practice, the DC-DC converter 141 and the output conversion circuit 142 are integrated and controlled. The configuration of the output part 14 is similar to that described in Patent Document 2, for example, and details will be described later.

The configuration is similar to a conventional charging device using a rectenna circuit. In the power circuit 1, the intensity (power value) of RF0 and the voltage and the current of DC1 are recognized, and DC2 output from the output part 14 is controlled accordingly. Therefore, the power circuit 1 includes an RF input monitor circuit 15 that monitors the power of RF0 and a DC input monitor circuit 16 that monitors the values of the voltage and the current of DC1. The output adjustment part 17 controls the output part 14 according to the measurement results and controls the current value of DC2 output from the output part 14 so that the power conversion efficiency from RF0 to DC2 is facilitated. As a result, in the power circuit 1, even if the intensity of RF0 fluctuates, the conversion efficiency can be maintained at a high level.

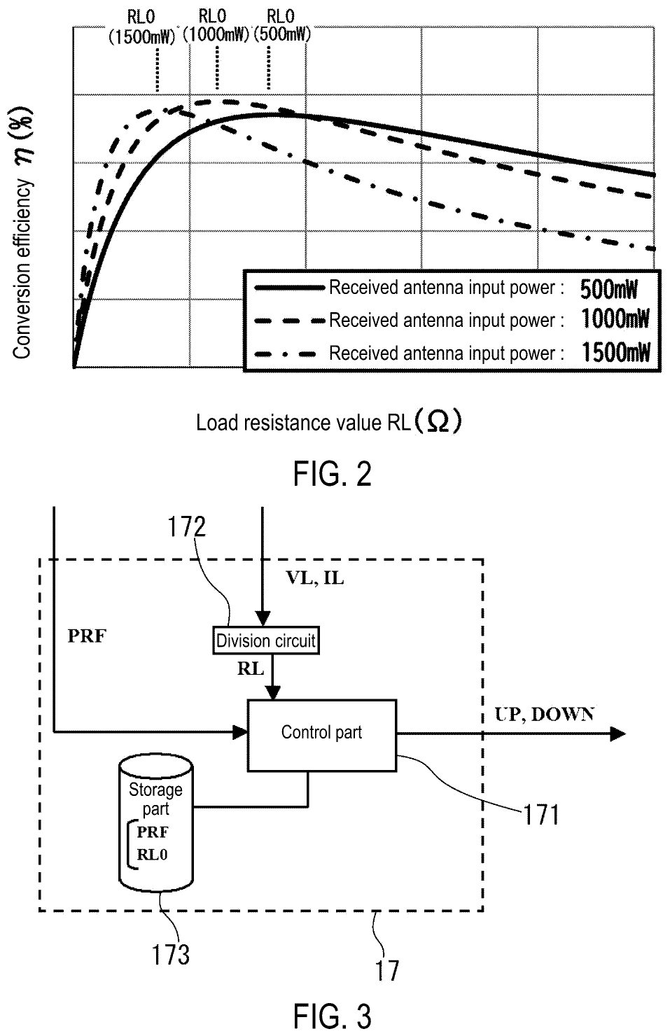

The operation will be specifically described below. As shown in FIG. 1, the output part 14 and the battery 100 can be considered as a virtual load resistance RL from the perspective of the rectifier circuit 13 or the DC input monitor circuit 16 at a preceding stage. In the power circuit 1, the control parameter is the value of the load resistance RL. A power conversion efficiency η from RF0 to DC2 depends on RL. FIG. 2 shows the measurement results of the RL dependency of n in the cases where a power PRF of RF0 is 500 mW, 1000 mW, and 1500 mW. According to the results, there is an RL (RL0) that maximizes the conversion efficiency η, and RL0 depends on PRF. The properties in FIG. 2 can be obtained for each PRF value, and PRF can be recognized by the RF input monitor circuit 15. Meanwhile, RL in FIG. 1 is the voltage/current of the output DC1 of the rectifier circuit 13, so RL can be recognized by the DC input monitor circuit 16.

Therefore, if the current PRF is known, the output adjustment part 17 can compare the recognized RL with the value of RL (RL0: optimal load resistance) at which the conversion efficiency η peaks in the properties of FIG. 2, and can control the increase or decrease of the current of DC2 accordingly. FIG. 3 shows in detail the configuration of the output adjustment part 17 for this purpose. Here, a control part 171 is provided to emit a signal for controlling the output part 14. The control part 171 receives the value of the current PRF from the RF input monitor circuit 15 and the value of the current RL obtained by using the voltage VL and the current IL of the current DC1 obtained from the DC input monitor circuit 16 by using a division circuit 172. Additionally, a memory part 173 is provided, in which the optimal RL value RL0 for each PRF is stored as a lookup table. The control part 171 can recognize the optimal load resistance RL0 corresponding to the currently recognized PRF from the lookup table. In practice, the memory part 173 stores respective RL0 for multiple discrete values of PRF, but the control part 171 can recognize RL0 corresponding to the currently recognized PRF by appropriately interpolating using the value of the current PRF and the values of respective PRF in the lookup table.

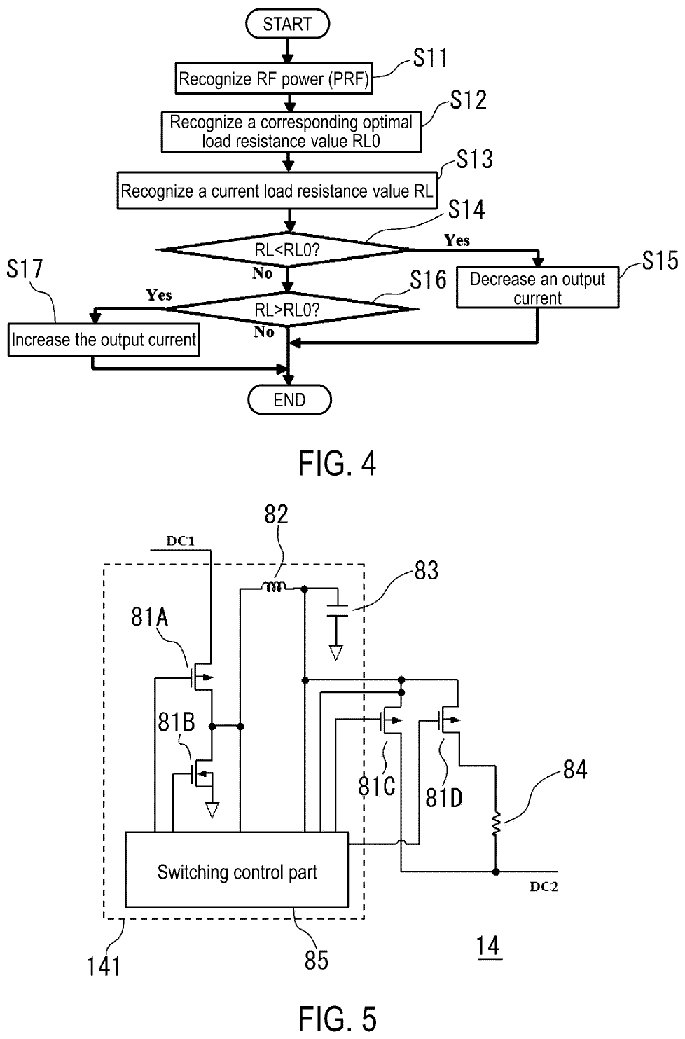

FIG. 4 is a flowchart showing the operation of the control part 171 at this time. First, the control part 171 obtains the value of the current PRF from the RF input monitor circuit 15 (S11) and recognizes the optimal load resistance RL0 corresponding thereto (S12). Next, the control part 171 obtains the value of the current RL from the side of the DC input monitor circuit 16 (division circuit 172) (S13).

The control part 171 controls the output part 14 according to the magnitude relationship between the value of the current RL and RL0. Specifically, in the case of RL<RL0 (S14: Yes), the control part 171 controls to decrease the output current from the output part 14 (S15). As a result, the subsequent RL becomes larger than the current RL, that is, RL approaches RL0. Comparatively, in the case of RL>RL0 (S16: Yes), the control part 171 controls to increase the output current from the output part 14 (S17). As a result, the subsequent RL becomes smaller than the current RL, that is, RL approaches RL0. The amount of increase and decrease of the current are appropriately set according to the variation of RF0, so that overshoot and undershoot are less likely to occur. Additionally, the operation can be performed at a predetermined time interval corresponding to a time constant of the temporal variation of RF0, for example.

Therefore, with the operation, in the power circuit 1, even if the intensity of RF0 fluctuates, the state where the conversion efficiency η is high (a state close to the maximum value in FIG. 2) is maintained. At this time, the value of the current PRF and RL can be recognized in a state where DC1 is supplied. As a result, the output current to the battery 100 is constantly supplied, and the adverse effect (such as destruction of the rectifier element) that occurs when the output current stops temporarily does not occur.

FIG. 5 is a simplified circuit diagram showing an example of the configuration of the output part 14 that realizes the operation. The circuit is a simplified version of the charging IC described in Patent Document 2. As shown in the figure, FETs 81A to 81D, an inductor 82, a capacitor 83, a resistor 84, and a switching control part 85 that controls the switching of each FET are provided. Here, the portion enclosed by the dashed line (FET 81A, 81B, inductor 82, capacitor 83, switching control part 85) operates as a conventional DC-DC converter 141 that converts the voltage of the input DC0. That is, DC1, which is a DC voltage, is pulsed by the ON/OFF operation of the FETs 81A and 81B, and then boosted (or stepped down) by using the inductor 82 and the capacitor 83. At this time, the voltage can be controlled by controlling the duty ratio of the pulse by using the switching control part 85.

Meanwhile, the switching control part 85 also controls ON/OFF of the FETs 81C and 81D. In the case where the FET 81C is ON and the FET 81D is OFF, the output of the DC-DC converter becomes the output DC2 of the output part 14 as is, whereas in the case where the FET 81C is OFF and FET 81D is ON, the output of the DC-DC converter is output through the resistor 84. Therefore, the output current of the output part 14 can be made lower than in the former case.

Therefore, if multiple types of the resistor 84 and the FET 81D connected to the resistor 84 are provided, the output current can be adjusted. In addition, since the switching control part 85 also controls the DC-DC converter 141, the current value of DC1 can be adjusted by adjusting the output voltage.

In addition to the adjustment of DC1 according to RL, the switching control part 85 can also perform control of the charging current that is particularly preferable for charging the battery 100, as described in Patent Document 2. That is, in the initial stage of charging of the battery 100, charging can be performed at a constant current (constant current charging), and after the potential of the battery 100 reaches a certain value, charging can be performed so that the voltage becomes a constant value (constant voltage charging). After that, when the current value of DC2 becomes equal to or less than a certain value, charging can be stopped.

Such control can be appropriately set according to the purpose (connected load) of the power circuit 1. In any case, compared to the technology described in Patent Document 1, the output current can be controlled without opening the output of the rectifier circuit 13. Therefore, the damage to the rectifier element is less likely to occur, and the current can be continuously output.

### Second Embodiment

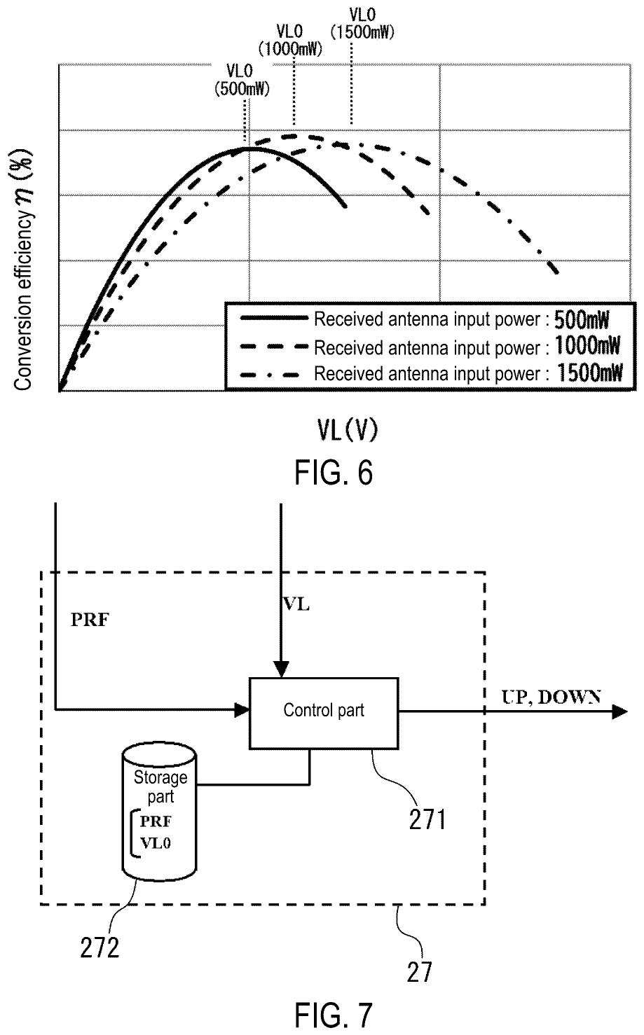

In the configuration of FIG. 1, the increase and decrease of the output current from the output part 14 is adjusted by using the virtual load resistance RL as a control parameter. Similar control can also be performed by using other measured quantities as control parameters. In the semiconductor device according to the second embodiment, the control parameter can be the voltage VL (first output voltage) of DC1 (first DC signal). FIG. 6 shows, similar to FIG. 2, the measurement results of the VL dependency of n in the cases where the power PRF of RF0 is 500 mW, 1000 mW, and 1500 mW. In such property as well, there is a VL (VL0: optimal voltage) that maximizes the conversion efficiency η, and VL0 depends on PRF. Therefore, similar control can be performed by using VL.

FIG. 7 shows the configuration of an output adjustment part 27 used in place of the output adjustment part 17 in FIG. 1 in this case, corresponding to FIG. 3. Here, only VL is used. Also, the lookup table stored in a memory part 272 includes the value VL0 (VL at the peak in FIG. 6) of the optimal VL for each PRF.

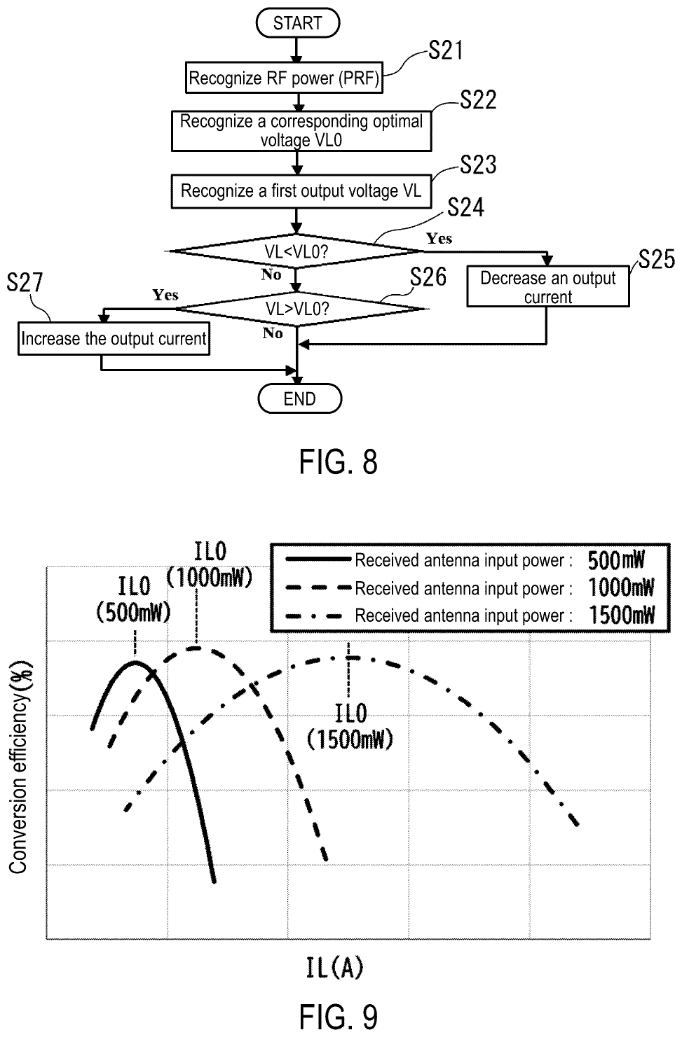

FIG. 8 shows the operation of the control part 271 in this case, corresponding to FIG. 4. In the operation, RL (RL0) in FIG. 4 is replaced with VL (VL0). In such case, while both VL and IL are necessary in the operation of FIG. 4, similar control can be performed by using only VL in the operation of FIG. 8. Therefore, the configuration of the DC input monitor circuit 16 in FIG. 1 can be simplified, and the cost of the power circuit can be reduced. Meanwhile, since only VL is used as the information, using the output adjustment part 17 that uses IL along with VL can allow more optimal control.

### Third Embodiment

In the second embodiment, the voltage VL (first output voltage) of DC1 (first DC signal) is used as the control parameter. Comparatively, in the third embodiment, the current IL (first output current) of DC1 (first DC signal) obtained from the DC input monitor circuit 16, similar to VL, is used instead of VL. Therefore, while the DC input monitor circuit 16 in the second embodiment only needs to recognize the voltage VL of DC1, in such case, the DC input monitor circuit 16 only needs to recognize the current IL of DC1, and similarly, the configuration of the DC monitor circuit 16 can be simplified.

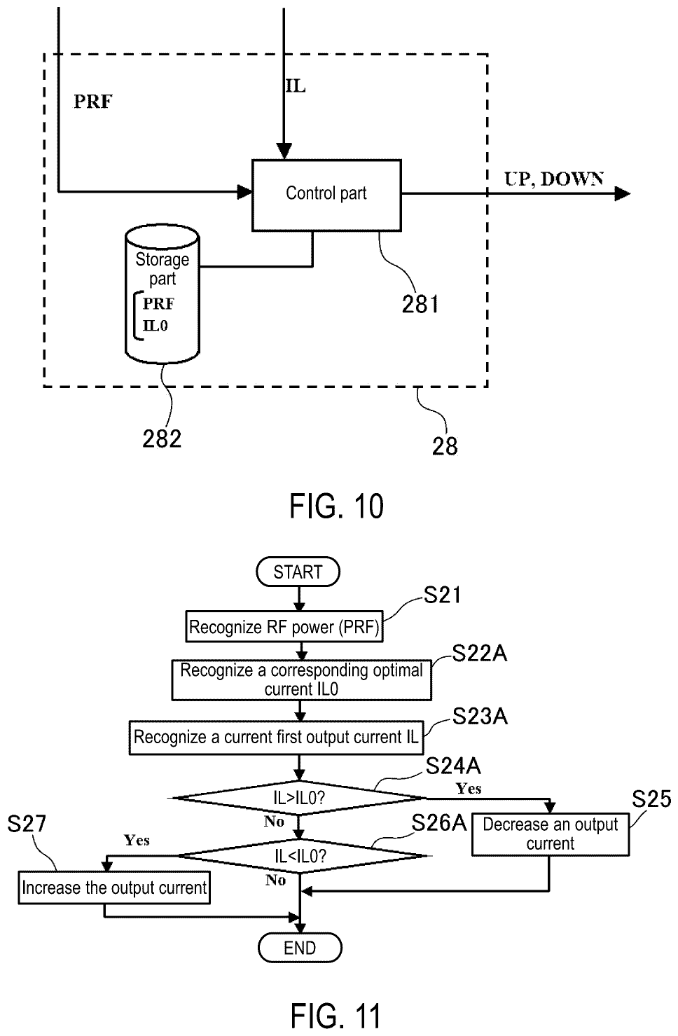

FIG. 9 corresponds to FIG. 6 and shows the measurement results of the IL dependency of n in such case. In such property as well, there is an IL (ILO: optimal current) that maximizes the conversion efficiency η, and ILO depends on PRF. Therefore, similar control can be performed by using IL. Also, FIG. 10 shows the configuration of an output adjustment part 28 used in place of the output adjustment part 17 in FIG. 1 in such case, corresponding to FIG. 3. Here, a control part 281 that controls the output part 14 by using only IL is used. Also, the lookup table stored in a memory part 282 includes the value ILO (IL at the peak in FIG. 9) of the optimal IL for each PRF.

FIG. 11 shows the operation of the control part 271 in this case, corresponding to FIGS. 4 and 8. In the operation, the voltage VL (VL0) in FIG. 8 is replaced with the current IL (ILO), and Steps S22, S23, S24, and S26 in FIG. 8 are changed to Steps S22A, S23A, S24A, and S26A in FIG. 11. Here, due to the change of the control parameter from voltage to current, the magnitude relationship of current in Steps S24A and S26A is reversed with respect to the magnitude relationship of voltage in Steps S24 and S26. There are no other changes, and similarly, the output current from the output part 14 is controlled, and high conversion efficiency η is maintained.

The specific situation of the first DC signal DC1 (voltage VL, current IL) varies according to the received high-frequency signal, the antenna 11, the matching circuit 12, etc. In such case, whether to use VL (second embodiment) or IL (third embodiment) to control the output current can be appropriately set according to such situation.

### Fourth Embodiment

Additionally, information related to the waveform of the voltage VL of DC1 can also be used as the control parameter. Such information includes the elapsed time of VL (rise time) from the start of power supply of RF0 in the state where DC1 is OFF, and, in the power circuit 2 according to the fourth embodiment, control using this rise time is performed. Also, in the example, similar to the technology described in Patent Document 1, although a switch for controlling ON/OFF of DC1 is used, control is performed so that the rectifier element is not damaged even in the case where the RF power is large. Furthermore, compared to the technology described in Patent Document 1, the time during which DC1 is OFF is only a short initial period, and during the continuous control on the output current afterwards, DC1 is continuously kept ON.

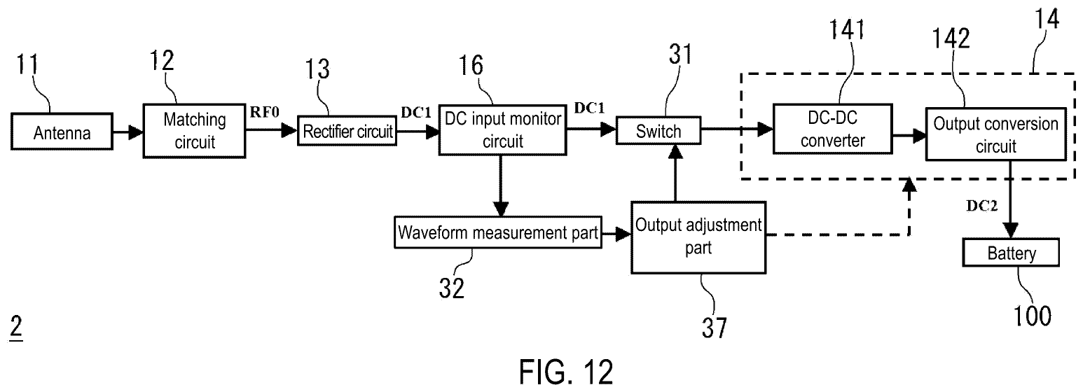

FIG. 12 is a diagram showing the configuration of the power circuit 2 corresponding to FIG. 1. Here, similar to the technology described in Patent Document 1, a switch 31 is provided at the output of the DC input monitor circuit 16. Therefore, the first output voltage VL can be measured in both ON state and OFF state of the switch 31. Additionally, a waveform measurement part 32 is provided to monitor the waveform of VL in a high time resolution, so that t1, which will be described later, can be recognized, and the output adjustment part 37 controls the output part 14 according to the measurement result of the waveform measurement part 32. In this case, unlike the power circuit 1, the RF input monitor circuit 15 is not necessary.

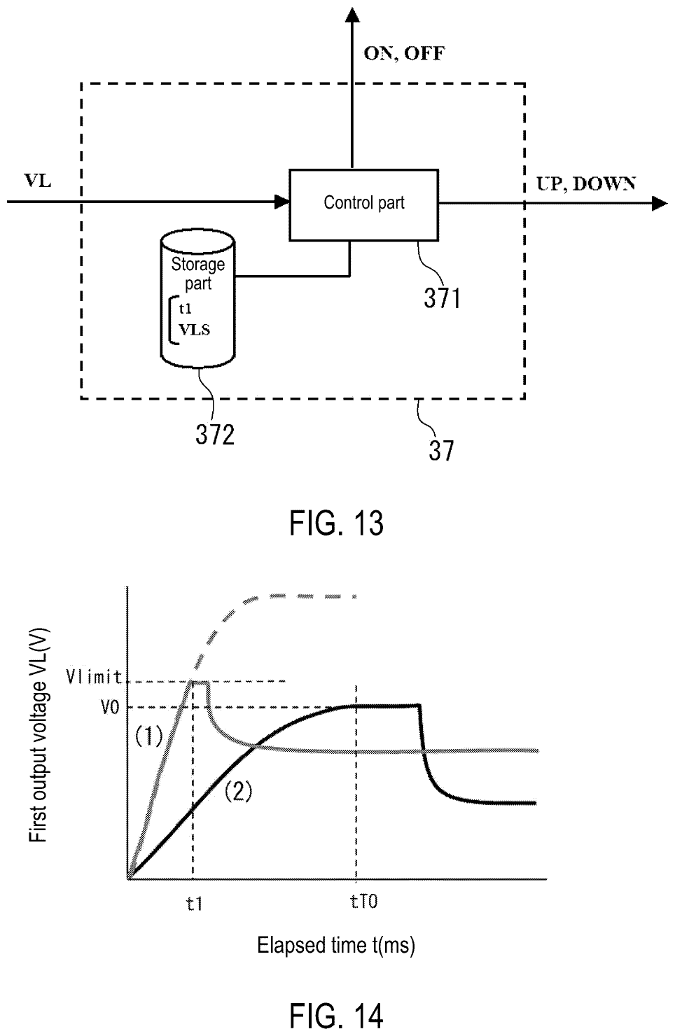

FIG. 13 shows the configuration of the output adjustment part 37 in this case corresponding to FIG. 3. Here, a control part 371 that controls the switch 31 and the output part 14 according to VL (elapsed time) recognized by the waveform measurement part 32, and a memory part 372 that stores data (lookup table) necessary for control are provided.

FIG. 14 shows the progression over time of the voltage (first output voltage) VL of DC1 recognized by the waveform measurement part 32 in the power circuit 2, in the case where PRF is large (1) and in the case where PRF is small (2). Here, the switch 31 is set to OFF in the initial state (elapsed time=0). In such case, due to the start of the input (power supply) of RF0, VL (in this case, the open output voltage) rises from 0. Here, the case (1) where PRF is large corresponds to a situation where the rectifier element of the rectifier circuit 13 is damaged when there is no control, and the case (2) where PRF is small corresponds to a situation where there is no risk of such damage.

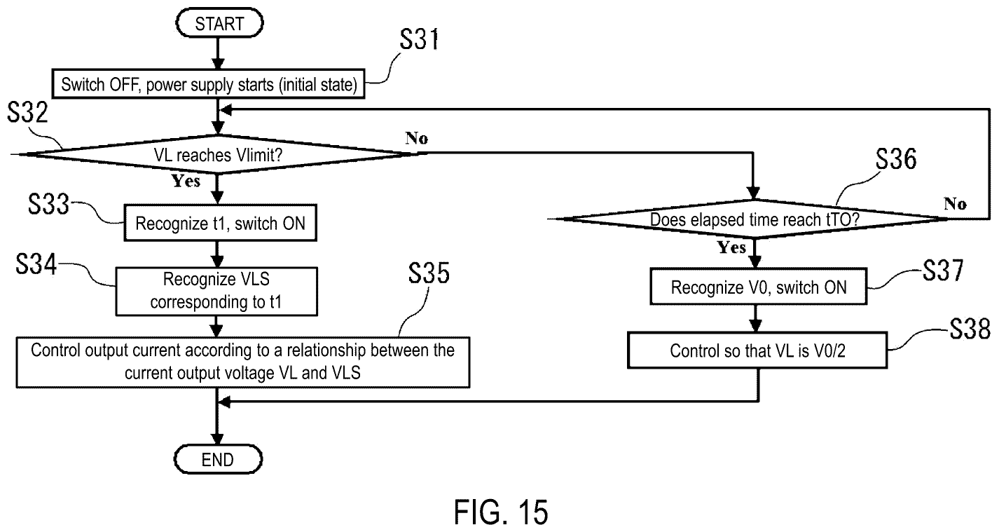

FIG. 15 is a flowchart showing the operation of the control part 371 in such case. Here, the initial state (S31) is the time point when the power supply of RF0 starts with the switch 31 in the OFF state. After that, as shown in (1) or (2) in FIG. 14, the open output voltage VL rises according to the elapsed time.

Here, a permissible voltage (maximum open output voltage) Vlimit for VL is set, and whether VL reaches Vlimit is recognized (S32). As mentioned above, in the case of (1), if the OFF state of the switch 31 continues after VL rises and reaches Vlimit, as shown by the dotted line, VL may become excessive, and the rectifier element may be destroyed. Therefore, the control part 371, in response to VL reaching Vlimit (S32: Yes), turns ON the switch 31 and recognizes the elapsed time (rise time) t1 up to this point (S33). At this time, with the current being supplied, a voltage drop occurs, causing VL to decrease below Vlimit.

t1 is small (short rise time) when PRF is large, and large (long rise time) when PRF is small. In other words, t1 can be used instead of PRF.

Here, in the memory part 372, instead of the lookup table corresponding to the relationship between PRF and RL0 in the power circuit 1, a lookup table showing an optimal voltage VLS, which is the optimal value of VL (with the highest conversion efficiency) for each rise time t1, is stored. Therefore, the control part 371 can recognize the VLS corresponding to the t1 recognized here (S34). Thus, similar to the first embodiment, control can be performed to decrease the output current when VL is less than VLS, and to increase the output current when VL is larger than VLS (S35). At this time, although the switch 31 is set to OFF initially, as in the technology described in Patent Document 1, the switch 31 is continuously set to ON after t1.

Meanwhile, in such case, when PRF is small and VL is small, there may be a case where VL does not reach Vlimit even after sufficient time has elapsed. (2) of FIG. 14 is a diagram showing such situation. In this case, a timeout time tTO is set in advance, and whether the elapsed time up to now reaches tTO is determined (S36). In the case where the elapsed time becomes tTO (S36: Yes), the switch 31 is turned ON regardless of the value of VL, and the VL at this point is recognized as a limit open output voltage V0 (S37). Similar to the technology described in Patent Document 1, if the subsequent VL is set to V0/2 (S38), the conversion efficiency can be increased. In other words, in this case, because PRF is small, there is no risk of damaging the rectifier element even if the switch 31 is turned OFF, and the subsequent actual operation becomes similar to Patent Document 1.

In the operation, the switch 31 is turned OFF initially only for recognizing the rise time t1 or the limit open output voltage V0. At this time, since Vlimit is set, the rectifier element in the rectifier circuit 13 may not be damaged. Also, in the subsequent control of the output current (S35, S38), since the switch 31 is turned ON, the time during which the switch 31 is turned OFF is short. Additionally, the operation to recognize t1 or V0 or the beginning thereof (S31) can be appropriately performed at a timing according to the time constant of the variation of RF0 on a long time scale, and, in such case, the conversion efficiency of the output in response to the variation of RF0 on a short time scale is controlled to be larger through the control of the output current (S35, S38).

### Fifth Embodiment

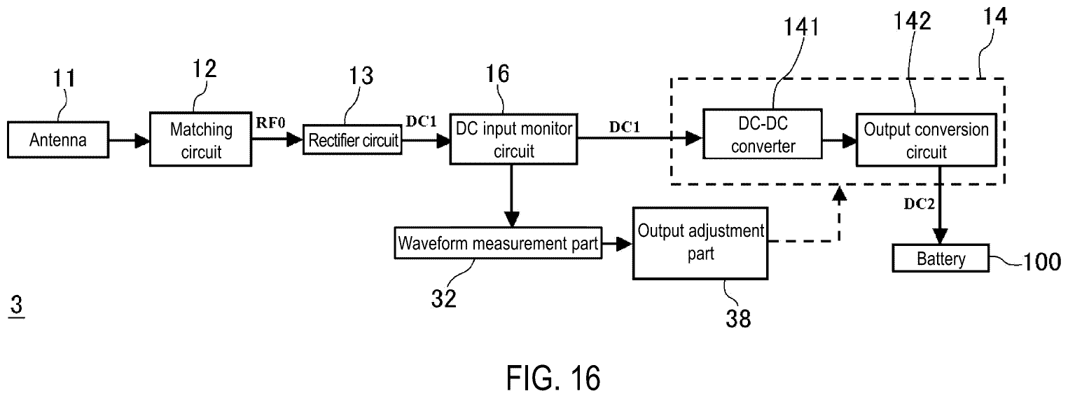

Similar to the fourth embodiment, the rise time of VL in FIG. 14 is used as the control parameter, but it is also possible to arrange a configuration that does not use a switch when performing the rising operation. FIG. 16 is a diagram showing the configuration of a power circuit 3 according to the fifth embodiment, corresponding to FIG. 12. Here, since the switch 31 is not used, the output adjustment part 38 does not perform the ON/OFF operation of the switch 31 in the power circuit 2.

Instead, the output adjustment part 38 performs an operation (initial control operation) that minimizes the current of DC2 to be substantially equivalent to the case where DC1 is not input to the output part 14. Apart from this point, the operation is similar to the power circuit 2 described above, and the operation (normal control operation) to control the current value of DC2 according to the rise time (control parameter) is switched from the initial control operation. In the normal control operation, the current value of DC2 is made larger than in the case of the initial control operation.

The current value of DC2 (second DC signal minimum setting value IL20) set in the initial control operation is set to be substantially similar to the operation that forcibly turns off DC1 input to the output part 14 in the power circuit 2, but such current value does not need to be zero and can be, for example, 10 mA. Therefore, the progression of VL over time from the state where DC2 is set in this way (a state substantially equivalent to when DC1 is turned OFF) and from the state where RF0 is input (power supply is started) is similar to FIG. 14. In FIG. 14, the voltage VL at the origin (power supply start time) is zero. Comparatively, the IL20 is set so that the voltage VL at the origin in this case is negligible enough to recognize the change of VL as shown in FIG. 14, although the voltage VL at the origin is not strictly zero in such case. Therefore, the operation in the power circuit 2 described above can be performed similarly.

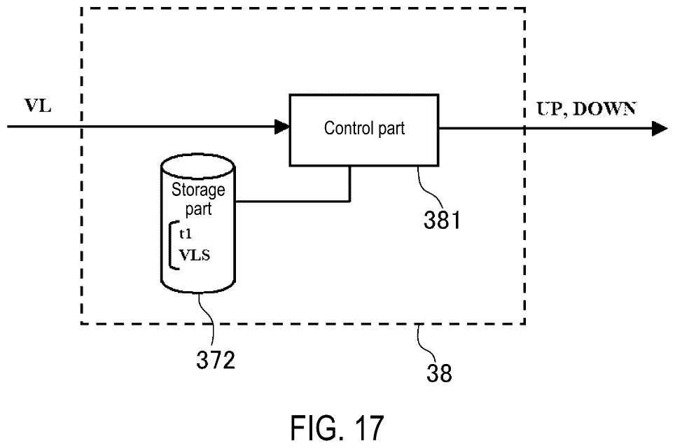

FIG. 17 shows the configuration of the output adjustment part 38 used in this case corresponding to FIG. 13. Here, a control part 381 that controls only the output part 14 according to VL (elapsed time) recognized by the waveform measurement part 32, and the memory part 372 are provided. In the case where IL20=0 is set in the power circuit 3, the operation of the power circuit 3 and the operation of the power circuit 2 are identical in principle. However, the control of the timing for turning ON/OFF the switch 31 in the power circuit 2 can be performed with higher precision than the control of the timing of performing the control of the current of DC2 by the output adjustment part in such case. On the other hand, although the precision of the timing control in the power circuit 3 is inferior to that of the power circuit 2 described above, the power circuit 3 can be made inexpensive because similar control can be performed without using the switch 31.

As the lookup table stored in the memory part 372 in this case, if the properties shown in FIG. 14 are substantially identical to those in the power device 2, the same lookup table used in the power device 2 can be used. Alternatively, if the properties shown in FIG. 14 have changed due to the provision of the IL20 (≠0), a lookup table using newly optimized parameters according to the change can be used.

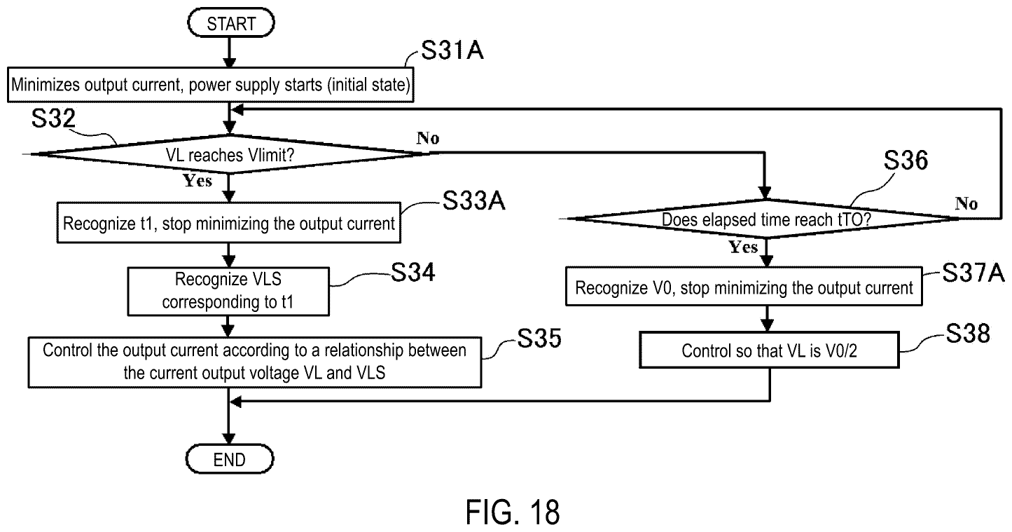

FIG. 18 is a flowchart showing the operation of the control part 381 in such case. Here, compared to the flowchart in FIG. 15, the difference is that, in the initial state, instead of the switch 31 being turned OFF (S31), the minimization of the output current (initial control operation) is performed (S31A), and subsequently, instead of the switch being turned ON (S33, S37), switching from the initial control operation to the normal control operation is performed (S33A, S37A), while other operations remain the same as those in FIG. 15. The setting of Vlimit, etc., is also similar.

Even for examples other than those described above, any quantity that is recognized from the DC signal after rectification and used for controlling the power conversion efficiency can be used as the control parameter. Accordingly, the content of the lookup table stored in the memory part can be appropriately set. Also, in the examples described above, RL0 (FIG. 2) and VL0 (FIG. 6) are set as points where the conversion efficiency η becomes maximum, but these do not necessarily have to correspond to the maximum value of the conversion efficiency η, and may be points where a desired conversion efficiency η is obtained.

It is clear that the invention is not limited to the embodiments, and each embodiment can be appropriately modified within the technical scope of the invention.

What is claimed is:

1. A power circuit that outputs a direct current (DC) signal generated based on a high frequency signal that is received to a load, the power circuit comprising:
a rectifier circuit, rectifying the high frequency signal and outputting a first DC signal;
an output part, outputting, as the DC signal, a second DC signal obtained by converting the first DC signal using a DC-DC converter; and
an output adjustment part, recognizing a control parameter recognized in accordance with an output state of the first DC signal, and controlling an increase or decrease of a current of the second DC signal output from the output part in accordance with the control parameter, so that a power conversion efficiency from the high frequency signal to the DC signal is facilitated.

2. The power circuit as claimed in claim 1, wherein the control parameter is a load resistance from a perspective from the rectifier circuit to a side of the load via the output part,
the power circuit comprises a memory part storing a lookup table indicating a relationship between a value of an optimal load resistance and high frequency power, the optimal load resistance being the load resistance that facilitates the power conversion efficiency, and the high frequency power being power of the high frequency signal,
the output adjustment part recognizes a current high frequency power and the load resistance and controls the output part based on the lookup table, so that:
the current of the second DC signal is increased in a case where the load resistance is higher than the optimal load resistance corresponding to the high frequency power that is recognized, and
the current of the second DC signal is decreased in a case where the load resistance is lower than the optimal load resistance corresponding to the high frequency power that is recognized.

3. The power circuit as claimed in claim 1, wherein the control parameter is a first output voltage that is a voltage of the first DC signal when the DC signal is supplied to a side of the load via the output part,
the power circuit comprises a memory part storing a lookup table indicating a relationship between a value of an optimal voltage and high frequency power, the optimal voltage being the first output voltage that facilitates the power conversion efficiency, and the high frequency power being power of the high frequency signal,
the output adjustment part recognizes a current high frequency power and the first output voltage and controls the output part based on the lookup table, so that:
the current of the second DC signal is increased in a case where the first output voltage is higher than the optimal voltage corresponding to the high frequency power that is recognized, and
the current of the second DC signal is decreased in a case where the first output voltage is lower than the optimal voltage corresponding to the high frequency power that is recognized.

4. The power circuit as claimed in claim 1, wherein the control parameter is a first output current that is a current of the first DC signal when the DC signal is supplied to a side of the load via the output part,
the power circuit comprises a memory part storing a lookup table indicating a relationship between a value of an optimal current and high frequency power, the optimal current being the first output current that facilitates the power conversion efficiency, and the high frequency power being power of the high frequency signal,
the output adjustment part recognizes a current high frequency power and the first output current and controls the output part based on the lookup table, so that:
the current of the second DC signal is decreased in a case where the first output current is higher than the optimal current corresponding to the high frequency power that is recognized, and
the current of the second DC signal is increased in a case where the first output current is lower than the optimal current corresponding to the high frequency power that is recognized.

5. The power circuit as claimed in claim 1, comprising a switch, controlling ON/OFF of the first DC signal between the rectifier circuit and the output part,
wherein a first output voltage is recognized, the first output voltage being a voltage of the first DC signal output from the rectifier circuit,
an maximum open output voltage is set, the maximum open output voltage being a maximum value with respect to an open output voltage that is a voltage of the first DC signal when the switch is OFF,
the control parameter is a rise time from a time when the high frequency signal is supplied when the switch is OFF until a time when the open output voltage reaches the maximum open output voltage,
the power circuit comprises a memory part storing a lookup table indicating a relationship between the rise time and a value of an optimal voltage that is the first output voltage that facilitates the power conversion efficiency when the switch is ON,
the output adjustment part recognizes the rise time and a current first output voltage based on the lookup table, so that:
the current of the second DC signal is increased in a case where the first output voltage is higher than the optimal voltage corresponding to the rise time that is recognized, and
the current of the second DC signal is decreased in a case where the first output voltage is lower than the optimal voltage corresponding to the rise time that is recognized.

6. The power circuit as claimed in claim 1, wherein a first output voltage is recognized, the first output voltage being a voltage of the first DC signal output from the rectifier circuit,
the output adjustment part is set to perform switching between two operations, which are: a normal control operation of controlling the increase or decrease of the current of the second DC signal in accordance with the control parameter that is recognized; and an initial control operation of controlling the current of the second DC signal to a constant value smaller than a value in the normal control operation without following the control parameter,
a maximum open output voltage is set, the maximum open output voltage being a maximum value with respect to an open output voltage that is a voltage of the first DC signal during the initial control operation,
the control parameter is a rise time from a time when the high frequency signal is supplied when the initial control operation is performed until a time when the open output voltage reaches the maximum open output voltage,
the power circuit comprises a memory part storing a lookup table indicating a relationship between the rise time and a value of an optimal voltage that is the first output voltage that facilitates the power conversion efficiency when the normal control operation is performed,
when performing the normal control operation, the output adjustment part recognizes the rise time and a current first output voltage based on the lookup table, so that:
the current of the second DC signal is increased in a case where the first output voltage is higher than the optimal voltage corresponding to the rise time that is recognized, and
the current of the second DC signal is decreased in a case where the first output voltage is lower than the optimal voltage corresponding to the rise time that is recognized.

7. The power circuit as claimed in claim 1, wherein the load is a battery, and the DC signal is used as a charging current.
